(19) United States
(12) Patent Application Publication
(10) Pub. No.: US 2018/0242314 A1
(43) Pub. Date: Aug. 23, 2018

(54) METHODS AND APPARATUSES FOR SETTING UP A SECONDARY UPLINK CARRIER IN A COMMUNICATIONS NETWORK

(71) Applicant: Telefonaktiebolaget LM Ericsson (publ), Stockholm (SE)

(72) Inventors: Nianshan Shi, Järfälla (SE); Martin Israelsson, Spånga (SE)

(21) Appl. No.: 15/554,524

(22) PCT Filed: Jun. 29, 2017
(86) PCT No.: PCT/SE2017/050723

§ 371 Date: Aug. 30, 2017

Related U.S. Application Data
(60) Provisional application No. 62/374,105, filed on Aug. 12, 2016.

(51) Int. Cl. H04W 72/04

(52) U.S. Cl. CPC H04W 72/0446; H04W 72/0433

(57) ABSTRACT

Embodiments herein relate to a method, performed by a Radio Network Controller, (RNC) for setting up a secondary uplink carrier. The RNC sends a dedicated radio link message to a network node. The dedicated radio link message comprises a first Information Element (IE) which indicates a Transmission Time Interval (TTI) value out of a plurality of TTI values available for the radio link. Embodiments herein further relate to a method, performed by a network node, for setting up a secondary uplink carrier. The network node receives the dedicated radio link message from the RNC. The dedicated radio link message comprises the first IE, which indicates a TTI value out of a plurality of TTI values available for the secondary uplink carrier that is to be set up.

### BACKGROUND

In a typical wireless communication network, wireless devices, also known as wireless communication devices, mobile stations, stations (STA) and/or user equipments (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a “NodeB” or “eNodeB”. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network. The EPS comprises an Evolved Universal Terrestrial Radio Access Network (E-UTRAN), also known as Long Term Evolution (LTE) radio access network, and an Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain.

Transmission Time Interval (TTI) is a parameter in telecommunication networks related to encapsulation of data from higher layers into frames for transmission on a radio link layer. TTI refers to the duration of a transmission on the radio link. The TTI is related to the size of the data blocks passed from the higher network layers to the radio link layer.

A Work Item “Multi-Carrier Enhancements for UMTS” has been agreed upon in 3GPP Release 14. The work item relates to enhanced support for new Transmission Time Interval (TTI) configurations for Dual Cell-High Speed Uplink Packet Access (DC-HSUPA) and Dual Band-Dual Cell-High Speed Uplink Packet Access (DB-DC-HSUPA) scenarios. Data scheduling on multi-carrier has been deployed to achieve higher data rates and load balancing. With the introduction of intra/inter-band features like DB-DC-HSPA/DC-HSPA, downlink and uplink data can be scheduled across two carriers for 2 ms TTI. However the uplink coverage of cells deployed in different carriers may be different and in some areas, especially at cell edges, the 2 ms TTI cannot be configured. In the current specification, when it comes to DC-HSUPA for example, it is explicitly stated that “Only 2 ms TTI is supported”. Hence, currently only 2 ms TTI for both carriers is supported for DC-HSUPA and DB-DC-HSUPA operations.

In order to deploy multi-carrier features in these scenarios, longer TTI may be configured for multi-carrier deployments. Thereby longer TTI may be configured on one carrier or two carriers when DB-DC-HSUPA/DC-HSUPA is configured in order to obtain higher data rates.

However, since legacy network nodes only support the 2 ms TTI, configuring a longer TTI for the one or more carriers will cause backwards non-compatibility problems.

### SUMMARY

It is therefore an object of embodiments herein to improve the performance in a communications network while ensuring backwards compatibility for legacy network nodes.

According to a first aspect of embodiments herein, the object is achieved by a method, performed by a Radio Network Controller (RNC), for setting up a secondary uplink carrier. The RNC sends a dedicated radio link message to a network node. The dedicated radio link message comprises a first Information Element (IE) which indicates a Transmission Time Interval (TTI) value out of a plurality of TTI values available for the radio link.

In a further embodiment herein the RNC may, prior to sending the dedicated radio link message to the network node, receive an indication from the network node, which indication indicates that the network node supports a variable TTI for the secondary uplink carrier.

The RNC may further determine to send the first IE in the dedicated radio link message based on the received indication from the network node, i.e. based on whether or not the network node supports a variable TTI.

In a further embodiment herein the dedicated radio link message may comprise a second IE, which IE indicates to the network node that a variable TTI configuration is set up. When the second IE indicates a variable TTI configuration, the value of the variable TTI may be indicated by the first IE. Hence, the variable TTI configuration may indicate that the secondary carrier supports variable TTI values. The variable TTI configuration may further indicate that both the first carrier and the secondary carrier support variable TTI values, and/or that the first and the second carrier may apply different TTI configurations, i.e. apply different TTI values.

According to a second aspect of embodiments herein, the object is achieved by a method, performed by a network node, for setting up a secondary uplink carrier, such as e.g. a secondary Uplink Enhanced Dedicated Channel (E-DCH) carrier in a radio communications network. The network node receives a dedicated radio link message. The dedicated radio link message comprises a first Information Element (IE) which indicates a Transmission Time Interval (TTI) value out of a plurality of TTI values available for the secondary uplink carrier.

In a further embodiment herein the network node may, prior to receiving the dedicated radio link message from the RNC, send an indication to the RNC, which indication indicates that the network node supports a variable TTI for the secondary uplink carrier. The network node may receive the IE in the dedicated radio link message based on the sent indication, i.e. based on whether or not the network node supports a variable TTI.

In a further embodiment herein the dedicated radio link message may comprise a second IE, which IE indicates to the network node that a variable TTI configuration is set up.

In a further embodiment the network node may set up the secondary uplink carrier in the radio communications network based on the TTI value indicated by the first IE comprised in the dedicated radio link message.

According to a third aspect of embodiments herein, the object is achieved by a Radio Network Controller (RNC) for performing a method for setting up a secondary uplink carrier. The RNC is configured to send a dedicated radio link message to a network node (130), wherein the dedicated radio link message comprises a first Information Element, IE, which indicates a Transmission Time Interval, TTI, value out of a plurality of TTI values available for the radio link.

According to a fourth aspect of embodiments herein, the object is achieved by a network node, for performing a method for setting up a secondary uplink carrier. The network node is configured to receive a dedicated radio link message from a Radio Network Controller (RNC). The dedicated radio link message comprises a first Information Element (IE) which indicates a Transmission Time Interval (TTI) value out of a plurality of TTI values available for the secondary uplink carrier.

Thereby the backwards non-compatibility issue caused by the introduction of the Release 14 new TTI configuration in DC-HSUPA/DB-DC-HSUPA in the secondary E-DCH carrier can be overcome.

### BRIEF DESCRIPTION OF THE DRAWINGS

Examples of embodiments herein are described in more detail with reference to attached drawings in which:

FIG. 1 is a schematic block diagram illustrating embodiments of a wireless communications network,

FIG. 2 is a flowchart depicting embodiments of a method performed in an RNC,

FIG. 3 is a flowchart depicting embodiments of a method performed in a network node,

FIG. 4 is a flowchart depicting embodiments of a method,

FIG. 5 is a schematic block diagram illustrating embodiments of a radio network node,

FIG. 6 is a schematic block diagram illustrating embodiments of RNC.

### DETAILED DESCRIPTION

As part of developing embodiments, a problem will first be identified and discussed. Please note that the terms “UE” and “user equipment” are used interchangeably in this document.

Today the secondary E-DCH can be setup with a Radio Link Setup procedure, or a Radio Link Reconfiguration procedure. TTI transmissions of 2 ms are always used and are thus not explicitly communicated from an RNC, such as e.g. a Serving Radio Network Controller (SRNC) to a NodeB and/or a Drifting Radio Network Controller (DRNC). Depending on the current connection the RNC may take different roles. When the RNC has a Radio Resource Control (RRC) connection with a UE it is referred to as an SRNC. When the UE roams to a cell which is controlled by another RNC, then we end up having two RNCs, wherein the one having RRC is the SRNC. The RNC that is added later is referred to as a DRNC. The SRNC controls the DRNC which in turn controls the cells. When a secondary HSUPA carrier/Additional E-DCH Cell is setup/added, there is no information about which TTI the carrier is going to use, since 2 ms TTI is mandatory.

As the standard so far only supports that both the primary and the secondary E-DCH carriers are on 2 ms TTI, there is no explicit Information Element (IE) when setting up the secondary E-DCH carrier to specify which TTI is used.

In the Release 14 Multi-Carrier Enhancements for UMTS feature, new possible TTI configurations, may be supported, such as e.g. 2 ms TTI+10 ms TTI, 10 ms TTI+10 ms TTI. This means that the secondary E-DCH carrier may be setup on 10 ms TTI as well. Hence, a way to specify the TTI value for the secondary E-DCH carrier is thus needed.

A straightforward solution might be to add an optional IE to indicate the TTI value when the secondary E-DCH carrier is setup or configured. However this will cause a backwards non-compatibility problem because it makes the meaning of “the absence of such a TTI IE” ambiguous:
Before Release 14, the IE does not exist, thus the absence of this IE means that 2 ms TTI will be used;
In Release 14 (when this feature is implemented), the absence of this IE means that the TTI value that was last communicated is not changed. This is due to the 3GPP design principle that over NBAP and RNSAP, when an optional IE is not included, it means that the value of this IE is not changed. So if the secondary E-DCH carrier is setup on a 10 ms TTI, and in a new Radio Link Reconfiguration procedure, if the TTI value is not changed, the TTI IE is thus absence from the message. These would however mean that the TTI value is not changed and should hence be a 10 ms TTI.

An object of embodiments herein is thus to provide a method for communicating a TTI value for a secondary carrier which improves the performance in a communications network and is compatible with legacy network nodes.

Embodiments herein may specify new TTI configurations: 2 ms+10 ms and ms+10 ms TTI, for DC-HSUPA and DB-DC-HSUPA scenarios.

Embodiments herein may further specify support for the basic functionality, e.g. only support for RRC based (re)configuration.

According to the embodiments herein support for the new TTI configurations is provided. The new configurations are 2 ms+10 ms and 10 ms+10 ms TTI, for DC-HSUPA and DB-DC-HSUPA scenarios.

In the current specification, such as e.g. in 3GPP TS 25.319 v13.0.0, it is explicitly stated for DC-HSUPA that “Only 2 ms TTI is supported” for a carrier. Hence, only 2 ms TTI for both carriers is supported for DC-HSUPA and DB-DC-HSUPA operations. When the secondary HSUPA carrier/Additional E-DCH Cell is setup/added, an E-TTI IE is not included.

To allow the new configuration, a new first IE, which is also referred to as an E-TTI IE, is added.

In a first embodiment the E-TTI IE may be added in the related IE groups handling the Additional E-DCH Cell.

The Node B may or may not support all the configurations, hence a specific Node B support indication for each configuration may be used, in the cell capability.

In a second embodiment new cell capabilities may be added to indicate Node B support.

As the legacy Node B always considers to set up the secondary E-DCH on 2 ms TTI, there may be ambiguity when E-TTI IE is not presented in the message during secondary E-DCH carrier reconfiguration. In order to resolve this ambiguity an abnormal case, also referred to as an abnormal condition, is also introduced herein. Embodiments herein provide a change to the NBAP/RNSAP 3GPP specification.

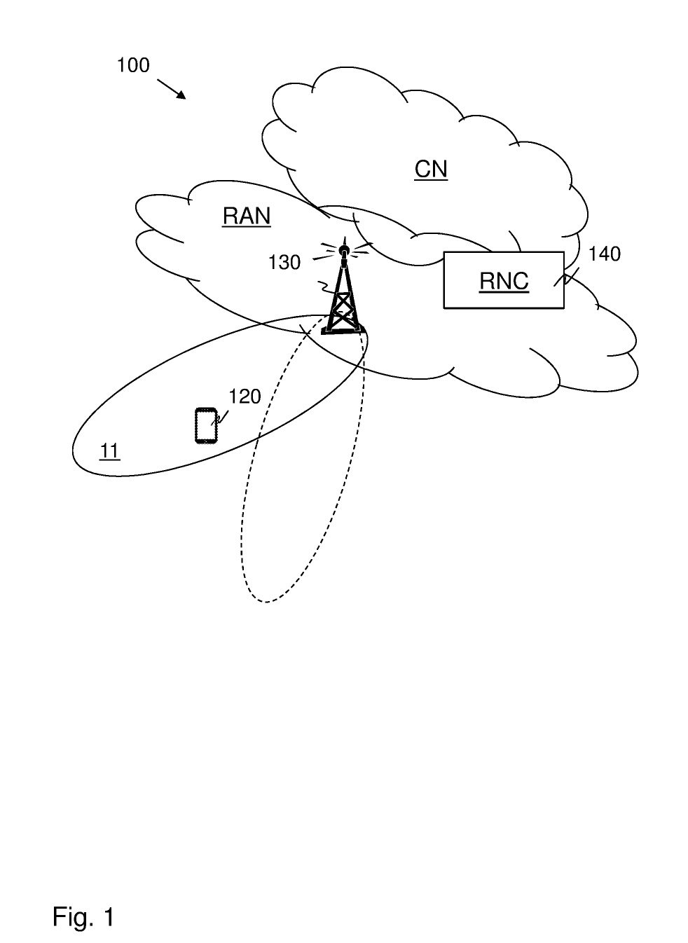

Embodiments herein relate to a communication networks in general. FIG. 1 is a schematic overview depicting a communication network 100. The communication network 100 may be a wireless communications network comprising one or more RANs and one or more CNs. The communication network 100 may use a number of different technologies, such as Wi-Fi, Long Term Evolution (LTE), LTE-Advanced, 5G, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices e.g. a wireless device 120 such as a mobile station, a non-access point (non-AP) STA, a STA, a user equipment (UE) and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The wireless communication network 100 comprises a network node 130 such as a radio network node providing radio coverage over a geographical area, a service area 11, which may also be referred to as a beam or a beam group where the group of beams is covering the service area of a first radio access technology (RAT), such as 5G, LTE, Wi-Fi or similar. The radio network node 130 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the radio network node 130 depending e.g. on the first radio access technology and terminology used. The radio network node 130 may be referred to as a serving radio network node and communicates with the wireless device 120 with Downlink (DL) transmissions to the wireless device 10 and Uplink (UL) transmissions from the wireless device 120. The wireless communication network 100 further comprises a RNC 140 which may control a network node 130 when connected to it.

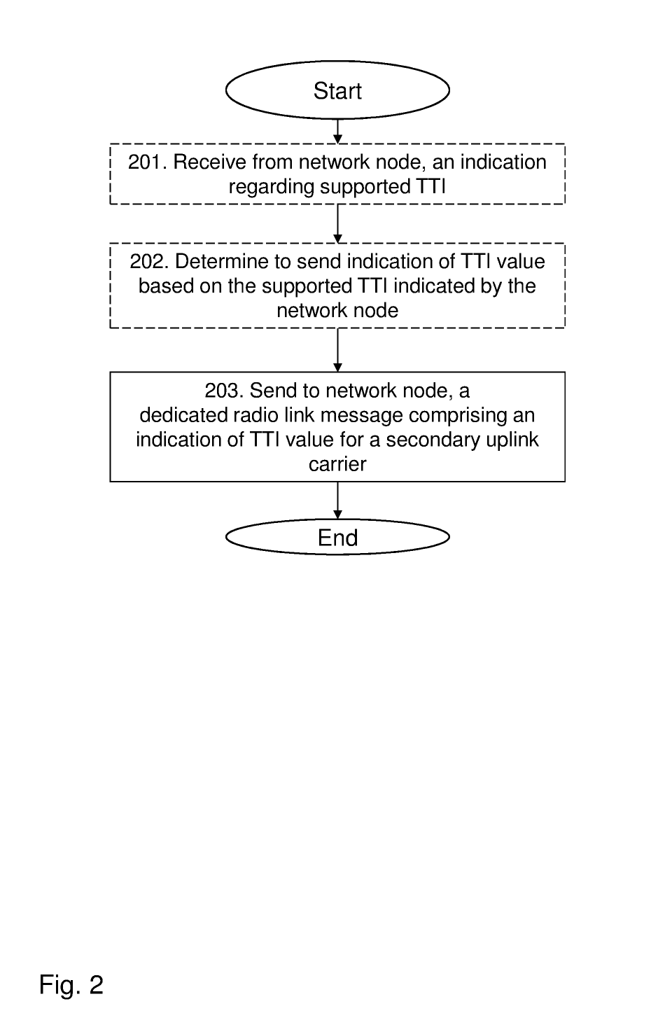

FIG. 2 discloses a flowchart depicting a method performed by the RNC 140, for setting up a secondary uplink carrier, such as e.g. a secondary Uplink Enhanced Dedicated Channel (E-DCH) carrier in a radio communications network. Actions performed in some embodiments only are marked with dashed boxes.

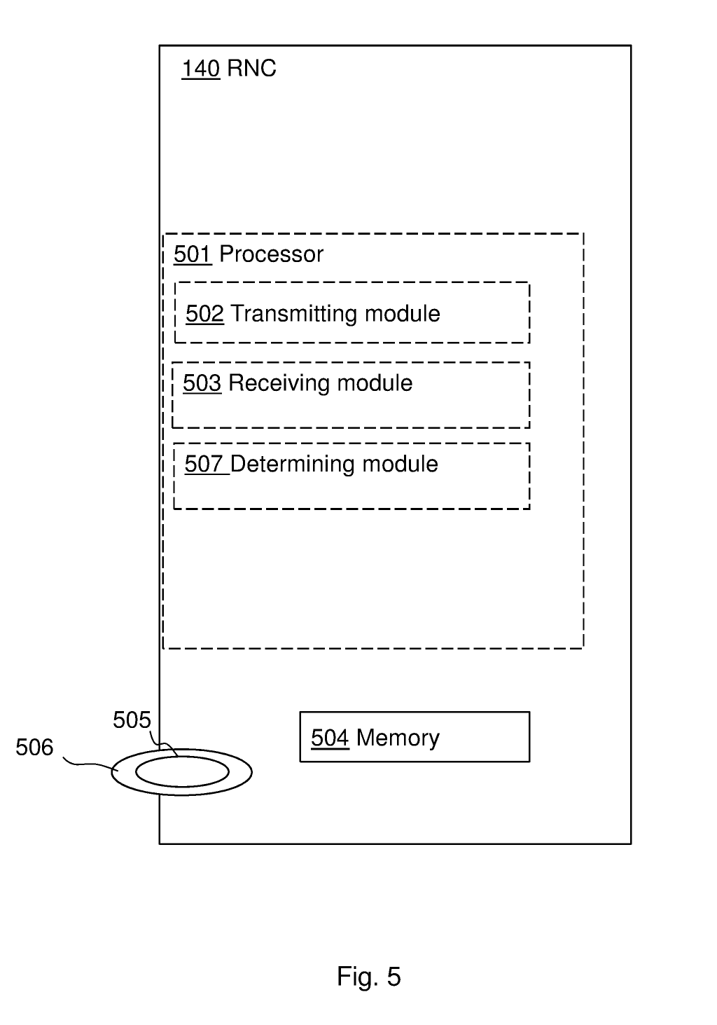

Action 201: The RNC 140 may receive an indication from the network node 130, wherein the indication indicates that the network node 130 supports a variable TTI for the secondary uplink carrier. This action corresponds with example embodiment B action 401 and example embodiment C step 1. The RNC may be configured to perform the action 201, e.g. by means of a receiving module configured to perform the action 201, see FIG. 5.

Action 202: The RNC 140 may determine to send an indication of a TTI value based on the supported TTI indicated by the network node 130. The RNC 140 may, e.g. determine to send a first Information Element (IE), which indicates a Transmission Time Interval (TTI) value, in a dedicated radio link message based on the received indication from the network node 130. The RNC 140 may be configured to perform the action 202, e.g. by means of a processor configured to perform the action 202, see FIG. 5.

Action 203: The RNC 140 sends a dedicated radio link message, such as e.g. a Radio Link Setup Request message, a Radio Link Reconfiguration Prepare message or a Radio Link Addition Request message, to the network node 130. The network node 130 may e.g. be a NodeB, an eNB and/or a DRNC. The dedicated radio link message comprises a first Information Element (IE) which indicates a Transmission Time Interval (TTI) value, such as e.g. 2 ms or 10 ms, out of a plurality of TTI values available for the radio link, such as e.g. 2 ms and 10 ms. The radio link may be the radio link on which the secondary uplink carrier is setup. The first IE may also be referred to as E-TTI, see e.g. example embodiments B and C and tables 1-8. The RNC may be configured to perform the action 203, e.g. by means of a transmitting module configured to perform the action 203, see FIG. 5.

In some embodiments, the dedicated radio link message may comprise a second IE, which second IE indicates to the network node 130 that a variable TTI configuration is set up. This may also be referred to as the second IE indicating a support of a variable TTI configuration. Hence, the variable TTI configuration may indicate that the secondary carrier supports variable TTI values. The variable TTI configuration may further indicate that both the first carrier and the secondary carrier support variable TTI values, and/or that the first and the second carrier may apply different TTI configurations, i.e. apply different TTI values. When the second IE indicates a variable TTI configuration or support of a variable TTI configuration, the value of the variable TTI may be indicated by the first IE in the radio link message, see e.g. table 5, 7 and 8. This may be done in order to setup the secondary uplink carrier.

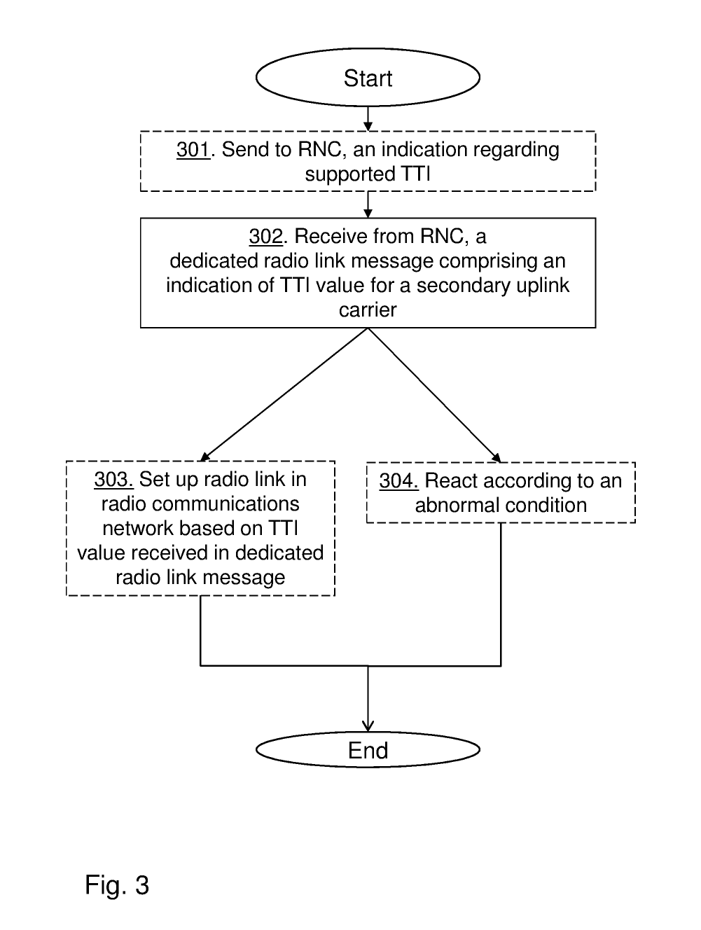

FIG. 3 discloses a flowchart depicting a method performed by the network node 130, for setting up a secondary uplink carrier, such as e.g. a secondary Uplink Enhanced Dedicated Channel (E-DCH) carrier in a radio communications network. Actions performed in some embodiments only are marked with dashed boxes.

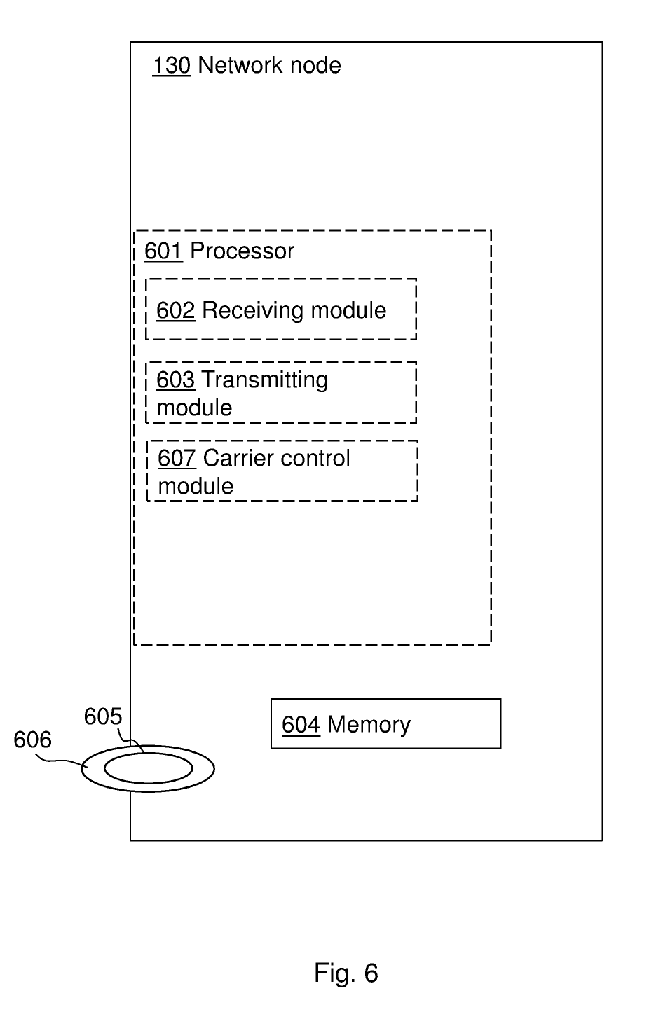

Action 301: The network node 130 may send an indication to the RNC 140, wherein the indication indicates that the network node 130 supports a variable TTI for the secondary uplink carrier, see e.g. embodiment B step 401 and example embodiment C step 1. The network node may be configured to perform the action 301, e.g. by means of a sending module configured to perform the action 301, see FIG. 6.

Action 302: The network node 130 receives a dedicated radio link message, such as e.g. a Radio Link Setup Request message, a Radio Link Reconfiguration Prepare message or a Radio Link Addition Request message, from the RNC 140. The dedicated radio link message comprises a first Information Element, IE, which first IE indicates a TTI value, such as e.g. 2 ms or 10 ms, out of a plurality of TTI values available for the secondary uplink carrier, such as e.g. 2 ms or 10 ms. The first IE corresponds to the TTI IE described in further detail in example embodiment A below. The first IE may also be referred to as E-TTI, see e.g. example embodiments B and C and tables 1-8. The network node may be configured to perform the action 302, e.g. by means of a receiving module configured to perform the Action 302, see FIG. 6.

When the network node 130 has sent the indication to the RNC 140, the network node 130 may receive the IE in the dedicated radio link message based on the sent indication, such that the network node 130 receives the IE when it has indicated that it supports a variable TTI. This embodiment corresponds to the example embodiment B described below.

In some embodiments herein the dedicated radio link message may comprise a second IE. The second IE indicates to the network node 130 that a variable TTI configuration is set up, which may also be referred to as the second IE indicating a support of a variable TTI configuration, for e.g. the secondary carrier. According to some embodiments herein, when the second IE indicates a variable TTI configuration, the value of the variable TTI may be indicated by the first IE. This embodiment corresponds to example embodiment C or D described in further detail below. The second IE may herein also be referred to as “New TTI Configuration Indicator”, “10 ms TTI Configuration Indicator” or “10 ms TTI Indicator”. When the second IE indicates a variable TTI configuration, the value of the variable TTI may be indicated by the first IE, see e.g. example embodiments C and D and table 5, 7 and 8.

Action 303: The network node 130 may set up a radio link in a radio communications network based on a TTI value received in a dedicated radio link message. The network node 130 may e.g. set up the secondary uplink carrier in the radio communications network based on the TTI value indicated by the first IE comprised in the dedicated radio link message. The network node may be configured to perform this action 303, e.g. by means of a processor configured to perform this action 303, see FIG. 6.

Action 304: When the network node 130 fails to execute the procedure based on the received dedicated radio link message, the network node 130 may react according to an abnormal condition. The abnormal condition may comprise failing the current secondary uplink carrier setup procedure. In a further embodiment the abnormal condition may comprise continuing the secondary uplink carrier setup procedure with a predefined TTI value. The network node may, when the network node fails to execute the procedure based on the received dedicated radio link message, react according to the Abnormal Condition specified in a Node B Application Part (NBAP) and/or a Radio Network Subsystem Application Part (RNSAP) specification for the dedicated radio link message. The network node may be configured to perform this action 304, e.g. by means of a processor configured to perform this action 304, see FIG. 6. The network node may e.g. fail to execute the procedure due to missing information in the message, such as e.g. a missing first and/or a second IE, or due to the network node not supporting a variable TTI for the secondary carrier. The abnormal conditions may e.g. specify that the network node shall fail the current secondary uplink carrier setup procedure or continue the secondary uplink carrier setup procedure with a predefined TTI value, such as e.g. 2 ms, see also alternative example embodiment C step 4.

### Example Embodiment A

A TTI IE, which may herein also be referred to as a first IE, for the secondary E-DCH carrier may be introduced with criticality defined as “Reject”. The possible values for the IE, which may also be referred to as E-TTI, may e.g. be 2 ms or 10 ms TTI. A clarification may be made to the specification that “the absence of this TTI IE means that the 2 ms TTI is used”. One example is to introduce this in the existing “Additional E-DCH FDD Information” IE, shown in Table 1. It is however also possible to introduce the E-TTI IE in other related IE groups or in other positions inside the IE groups.

A variation to embodiment A is that the new introduced E-TTI IE only has a value 10 ms. And a clarification is made to the specification that “the absence of this E-TTI IE means 2 ms TTI”, refer to Table 2.

This embodiment corresponds to Action 203 performed by the RNC 140 and Action 302 performed by the network node 130. This embodiment is very simple, but not easy to detect faults and not easy to specify handling when abnormal situation occurs.

### Example Embodiment B

The network node 130, such as a Node B, and/or a DRNC may indicate to the SRNC that it can handle, which may also be referred to as that it supports, the new TTI configurations (such as e.g. 2 ms TTI+10 ms TTI, 10 ms TTI+2 ms TTI, 10 ms TTI+10 ms TTI) in DC-HSUPA and DB-DC-HSUPA. In this case the DRNC may work as a relay between the NodeB and the SNRC. In other words, the network node may send an indication to the DRNC, which then forwards the indication to the SNRC. This corresponds to Action 201 performed by the RNC 140 and Action 301 performed by the network node 130. The RNC which supports the new TTI configuration will upon receiving of such an indication, always include the new E-TTI IE and indicate the TTI value when set up or reconfiguring the secondary E-DCH carrier. See e.g. Table 3 and Table 4.

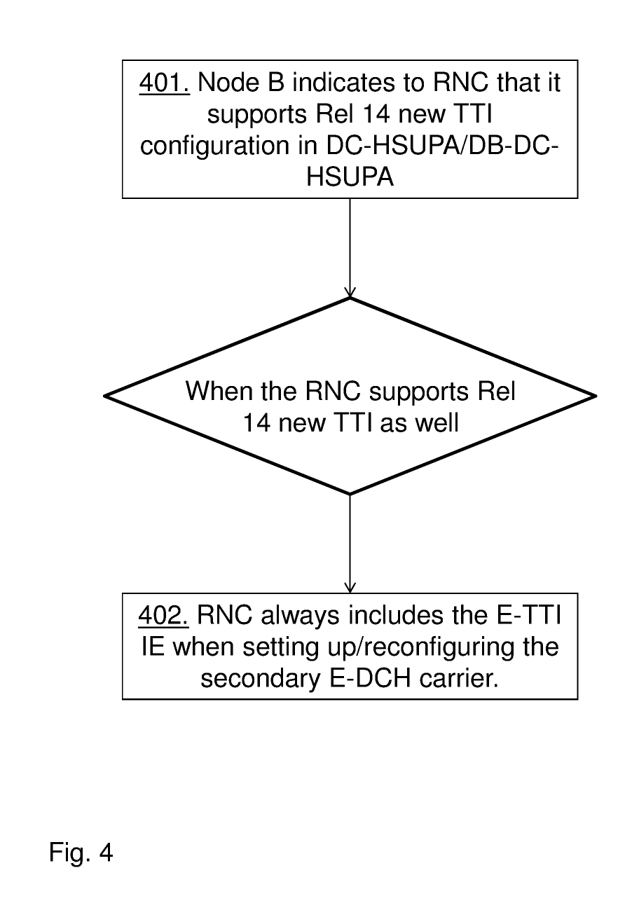

FIG. 4 discloses a flowchart depicting a method according to example embodiment B. The specification impacts:

Action 401: An explicit indication is sent from Node B/DRNC to RNC to state that it supports new TTI configuration in DC-HSUPA/DB-DC-HSUPA, in correspondence with Action 201 performed by the RNC 140 and Action 301 performed by the network node 130. It may be more beneficial to specify one indication for each TTI configuration (e.g. 2 ms+10 ms, 10 ms+2 ms, 10 ms+10 ms). This indication/indications may be set on Cell basis and may be included in an Audit and Resource Status Indication procedure, for example to be added to an existing Node B Cell Capability Container.

Another variation may be to indicate that the Node B supports to send up the secondary E-DCH in 10 ms TTI.

Action 402: The RNC always includes the E-TTI IE when setting up/reconfiguring the secondary E-DCH carrier. The NBAP/RNSAP specification may be modified to state if the Node B indicates its support for the new TTI configuration in DC-HSUPA and DB-DC-HSUPA and if the RNC supports the new configuration as well, it should always include the optional IE to specify the TTI value for the secondary E-DCH carrier. This embodiment puts the responsibility for sending the IE TTI on the SRNC.

### Example Embodiment C

The RNC indicates that the new TTI configuration for DC-HSUPA and DB-DC-HSUPA is going to be set up/added/reconfigured for the secondary E-DCH carrier. Another new E-TTI IE, which may herein also be referred to as a second IE, may be introduced as a “conditional IE”. The condition is specified as the E-TTI IE shall be presented if RNC indicates the new TTI configuration is setting up, i.e. the Indicator of new TTI configuration IE is presented. Refer to Table 5.

The Abnormal Conditions in NBAP/RNSAP specification in Radio Link Setup, Radio Addition, Radio Link Reconfiguration procedures may also be modified to state that: for the secondary E-DCH carrier, if RNC indicates the Rel 14 new TTI configuration is used for secondary E-DCH, or 10 ms TTI is used for the secondary E-DCH carrier, but the E-TTI IE is not presented, Node B should fail the current procedure, refer to Table 6.

Another variation of the embodiment C is if the Abnormal Condition is defined, the E-TTI IE may be introduced as an optional IE.

Another variation to embodiment C may be that the RNC indicates that the 10 ms TTI is used for the secondary E-DCH carrier and the TTI IE with only value 10 ms is introduced as “conditional IE”, refer to Table 7.

It an alternative embodiment embodiment B Action 401 may be combined with embodiment C. Such a specification impacts:
1 An explicit indication/indications is sent from the network node 130, such as a Node B and/or a DRNC to the RNC to state that it supports the Rel 14 new TTI configuration for DC-HSUPA and DB-DC-HSUPA.
2. The RNC indicates to the Node B that such a configuration is being set up.
3. A new E-TTI IE is introduced for the secondary E-DCH carrier.
4. The Abnormal Conditions in the NBAP and/or RNSAP specification in Radio Link Setup, Radio Addition or Radio Link Reconfiguration procedures may be modified to state that if the RNC indicates the Rel 14 TTI configuration and if the E-TTI IE is not presented, then the Node B shall fail the current procedure.

### Embodiment D

The RNC may indicate if the 10 ms TTI is going to be set up/added/reconfigured for the secondary E-DCH carriers, it also indicates if 10 ms TTI is removed, i.e. reconfigured to 2 ms TTI. Refer to Table 8. In the procedure text, it may be specified that this IE is used to indicate if 10 ms TTI is used or it is reconfigured to 2 ms TTI. The absence of the IE means that 2 ms TTI is used.

The embodiments described above may be implemented on the NBAP (3GPP TS 25.433 V13.0.0)/RNSAP (3GPP TS 25.423 v13.0.0) specification. The new IEs may be added to IEs related to a secondary E-DCH setting up/addition/reconfiguration, in the RADIO LINK SETUP REQUEST, RADIO LINK ADDITION REQUEST, and/or RADIO LINK RECONFIGURATION PREPARE messages.

Alternative Embodiments may also be implemented by combining the different steps in the embodiments presented, and by introducing the new IEs in some other places. These other places may e.g. be any other message sent between the RNC 140 and the network node 130.

Release 14 new TTI configuration in DC-HSUPA and DB-DC-HSUPA, as used herein allows that the primary carrier may e.g. be on 2 ms TTI or 10 ms TTI and the secondary carrier may be on 2 ms TTI or 10 ms TTI. However, other TTIs than 2 ms and ms may also be used.

The backwards non-compatibility issue caused by the introduction of the Release 14 new TTI configuration in DC-HSUPA/DB-DC-HSUPA in the secondary E-DCH carrier is overcome by embodiments herein. The embodiments herein may be able to read in the related specifications.

FIG. 5 is a block diagram depicting the Radio Network Controller (RNC) 140 for performing the method for setting up a secondary uplink carrier in the communications network 100. The RNC 140 may comprise a processing unit 501, such as e.g. one or more processors, configured to perform the method described herein, as performed by the RNC 140. Dashed lines of a box in FIG. 5 indicate that this box is not mandatory and relate to some embodiments only.

The RNC 140 is configured to, e.g. by means of a transmitting module 502 and/or the processing unit 501 being configured to, send a dedicated radio link message to the network node 130. The dedicated radio link message comprises a first Information Element, IE, which indicates a Transmission Time Interval (TTI) value out of a plurality of TTI values available for the radio link.

The RNC 140 may further be configured to, e.g. by means of the processing unit 501 or a receiving module 503 being configured to, receive, prior to sending the dedicated radio link message to the network node 130, an indication from the network node indicating that the network node 130 supports a variable TTI for the secondary uplink carrier.

The RNC 140 may further be configured to, e.g. by means of the processing unit 501 or a determining module 507 being configured to, determine to send the first IE in the dedicated radio link message based on the received indication from the network node 130.

The RNC 140 further comprises a memory 504. The memory 504 comprises one or more units to be used to store data on, such as system information, IDLE mode mobility information, network slice information, wireless device IDs, network slice and roaming policies, Slice IDs, applications to perform the methods disclosed herein when being executed, and similar.

The methods according to the embodiments described herein for the RNC 140 may respectively be implemented by means of e.g. a computer program 505 or a computer program product, comprising instructions, i.e. software code portions, which, when executed on at least one processor, cause the at least one processor to carry out the actions described herein, as performed by the determining module. The computer program 505 may be stored on a computer-readable storage medium 506, e.g. a disc or similar. The computer-readable storage medium 506, having stored thereon the computer program, may comprise the instructions which, when executed on at least one processor, cause the at least one processor to carry out the actions described herein, as performed by the determining module. In some embodiments, the computer-readable storage medium may be a non-transitory computer-readable storage medium.

FIG. 6 is a block diagram depicting the network node 130 for performing the method for setting up a secondary uplink carrier. The network node 130 may comprise a processing unit 601, such as e.g. one or more processors, configured to perform the method described herein, as performed by the network node 130. Dashed lines of a box in FIG. 6 indicate that this box is not mandatory and relate to some embodiments only.

The network node 130 is configured to, e.g. by means of a receiving module 602 and/or the processing unit 601 being configured to, receive a dedicated radio link message from the RNC 140. The dedicated radio link message comprises a first Information Element (IE) which indicates a Transmission Time Interval (TTI) value out of a plurality of TTI values available for the secondary uplink carrier.

The network node 130 may further be configured to, e.g. by means of the processing unit 601 or a transmitting module 603 being configured to, send, prior to receiving the dedicated radio link message from the RNC, an indication to the RNC, wherein the indication indicates that the network node supports a variable TTI for the secondary uplink carrier.

The network node 130 may further be configured to, e.g. by means of the processing unit 601 or a carrier control module 607 being configured to, set up the secondary uplink carrier in the radio communications network based on the TTI value indicated by the first IE comprised in the dedicated radio link message.

The network node 130 may further be configured to, e.g. by means of the processing unit 601 or the carrier control module 607 being configured to, react according to an abnormal condition, when the network node fails to execute the procedure based on the received dedicated radio link message. The abnormal condition may comprise failing the current secondary uplink carrier setup procedure. In a further embodiment the abnormal condition may comprise continuing the secondary uplink carrier setup procedure with a predefined TTI value.

The network node 130 further comprises a memory 604. The memory 604 may comprise one or more units to be used to store data on, such as system information, IDLE mode mobility information, network slice information, wireless device IDs, network slice and roaming policies, Slice IDs, applications to perform the methods disclosed herein when being executed, and similar.

The methods according to the embodiments described herein for the network node 130 may respectively be implemented by means of e.g. a computer program 605 or a computer program product, comprising instructions, i.e., software code portions, which, when executed on at least one processor, cause the at least one processor to carry out the actions described herein, as performed by the determining module. The computer program 605 may be stored on a computer-readable storage medium 606, e.g. a disc or similar. The computer-readable storage medium 606, having stored thereon the computer program, may comprise the instructions which, when executed on at least one processor, cause the at least one processor to carry out the actions described herein, as performed by the determining module. In some embodiments, the computer-readable storage medium may be a non-transitory computer-readable storage medium.

As will be readily understood by those familiar with communications design, that functions means or modules described herein may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes will appreciate the cost, performance, and maintenance trade-offs inherent in these design choices.

The embodiments herein may be implemented through one or more processors, such as the processor 501 in the RNC 140 depicted in FIG. 5, and the processor 601 in the network node 130 depicted in FIG. 6 together with computer program code for performing the functions and actions of the embodiments herein. The program code mentioned above may also be provided as a computer program product, for instance in the form of a data carrier carrying computer program code for performing the embodiments herein when being loaded into the network node 130 and the RNC 140. One such carrier may be in the form of a CD ROM disc. It is however feasible with other data carriers such as a memory stick. The computer program code may furthermore be provided as pure program code on a server and downloaded to the network node and RNC.

Thus, the methods according to the embodiments described herein performed by the network node and the RNC may be implemented by means of a computer program product, comprising instructions, i.e., software code portions, which, when executed on at least one processor, cause the at least one processor to carry out the actions described herein, as performed by the network node and the RNC. The computer program product may be stored on a computer-readable storage medium. The computer-readable storage medium, having stored there on the computer program, may comprise the instructions which, when executed on at least one processor, cause the at least one processor to carry out the actions described herein, as performed by the network node and the RNC. In some embodiments, the computer-readable storage medium may be a non-transitory computer-readable storage medium.

The network node 130 and RNC 140 may further each comprise a memory 504, 604 comprising one or more memory units. The memory is arranged to be used to store obtained information such as indications of a mobility set, identifiers of APs and WLANs, identifiers of UEs, ciphering keys, measurements of signals from radio access nodes, measurement reports or parts thereof and applications etc. to perform the methods herein when being executed in the network node and RNC.

In some embodiments, a computer program comprises instructions, which when executed by the at least one processor such as the processing unit 501, 601, cause the at least one processing unit 501, 601 to perform actions according to any of the above Actions.

Hence, in some embodiments the RNC may comprise a processor and a memory, said memory containing instructions executable by said processor whereby said RNC is operative to perform the method steps 201-203 as described above.

Correspondingly, in some embodiments, the network node may comprise a processor and a memory, said memory containing instructions executable by said processor whereby said network node is operative to perform the method steps 301-304 as described above.

In some embodiments, a carrier comprises the computer program, wherein the carrier is one of an electronic signal, an optical signal, an electromagnetic signal, a magnetic signal, an electric signal, a radio signal, a microwave signal, or a computer-readable storage medium.

Table 1, below is extract from TS 25.433 (v. 12.0.0), 9.2.2.137 Additional E-DCH FDD Information. In this example, a new IE “E-TTI” is introduced which may be set to “2 ms” or “10 ms”. It may also be specified that “the absence of this IE means 2 ms III”

| IE/Group | | | IE Type and | Semantics | | Assigned |
|---|---|---|---|---|---|---|
| Name | Presence | Range | Reference | Description | Criticality | Criticality |
| Additional | | 0 . . . <maxNrOfEDCHMACdFlows> | | | | |
| E-DCH | | | | | | |
| MAC-d | | | | | | |
| Flows | | | | | | |
| Specific | | | | | | |
| Information | | | | | | |
| >E-DCH | M | | 9.2.1.74 | | — | |
| MAC-d | | | | | | |
| Flow ID | | | | | | |
| >Binding | O | | 9.2.1.4 | Shall be | — | |
| ID | | | | ignored if | | |
| | | | | bearer | | |
| | | | | establishment | | |
| | | | | with ALCAP | | |
| >Transport | O | | 9.2.1.63 | Shall be | — | |
| Layer | | | | ignored if | | |
| Address | | | | bearer | | |
| | | | | establishment | | |
| | | | | with ALCAP | | |
| HARQ | O | | HARQ | | — | |
| Process | | | Process | | | |
| Allocation | | | Allocation for | | | |
| For 2 ms | | | 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum Set | | | (0 . . . 127) | concept of “E- | | |
| E-TFCI | | | | DCH Minimum | | |
| | | | | Set of TFCs” | | |
| | | | | see TS 25.321 | | |
| | | | | [32] and TS | | |
| | | | | 25.331 [18] | | |
| DTX | | 0 . . . 1 | | | | |
| Information | | | | | | |
| 2 | | | | | | |
| >UE DTX | M | | ENUMERATED | Units of | YES | ignore |
| Cycle 1 | | | (v1, v4, | subframes, | | |
| | | | v5, v8, v10, | refer to TS | | |
| | | | v16, v20, . . .) | 25.331 [16]. | | |
| >UE DTX | M | | ENUMERATED | Units of | YES | ignore |
| Cycle 2 | | | (v4, v5, | subframes, | | |
| | | | v8, v10, v16, | refer to TS | | |
| | | | v20, v32, | 25.331 [16]. | | |
| | | | v40, v64, | | | |
| | | | v80, v128, | | | |
| | | | v160, v256, | | | |
| | | | v320, v512, | | | |
| | | | v640, v1024, | | | |
| | | | v1280, . . .) | | | |
| >Inactivity | M | | ENUMERATED | Units of E- | YES | ignore |
| Threshold | | | (v1, v4, | DCH TTIs, | | |
| for UE DTX | | | v8, v16, v32, | refer to TS | | |
| Cycle 2 | | | v64, v128, | 25.331 [16]. | | |
| | | | v256, . . .) | | | |
| Implicit Grant | O | | ENUMERATED | The presence | YES | ignore |
| handling | | | (true) | of this | | |
| | | | | information | | |
| | | | | element | | |
| | | | | indicates that | | |
| | | | | Implicit Grant | | |
| | | | | handling is | | |
| | | | | configured on | | |
| | | | | the secondary | | |
| | | | | uplink | | |
| | | | | frequency | | |
| Minimum | O | | ENUMERATED | In bytes | YES | ignore |
| TEBS | | | (v2, v4, | And N Kbytes = | | |
| threshold | | | v8, v16, v32, | N*1024 | | |
| | | | v64, v128, | bytes. Twelve | | |
| | | | v256, v512, | spare values | | |
| | | | v1024, v2K, | are needed, | | |
| | | | v4K, v8K, | refer to TS | | |
| | | | v16K, v32K, | 25.331 [16]. | | |
| | | | v64K, | | | |
| | | | v128K, | | | |
| | | | v256K, | | | |
| | | | v512K, | | | |
| | | | V1024K, . . .) | | | |
| E-TTI | O | | ENUMERATED | The | YES | reject |
| | | | (2 ms, | absence of | | |
| | | | 10 ms) | this IE | | |
| | | | | means 2 ms | | |
| | | | | TTI. | | |

Table 2, below is extract from TS 25.433 (v. 12.0.0), 9.2.2.137 Additional E-DCH FDD Information. In this example, a new IE “E-TTI” is introduced which may be set to “10 ms”. It may also be specified that “the absence of this IE means 2 ms III”

| IE/Group | | | IE Type and | Semantics | | Assigned |
|---|---|---|---|---|---|---|
| Name | Presence | Range | Reference | Description | Criticality | Criticality |
| Additional E- | | 0 . . . <maxNrOfEDCHMACdFlows> | | | | |
| DCH MAC-d | | | | | | |
| Flows | | | | | | |
| Specific | | | | | | |
| Information | | | | | | |
| >E-DCH | M | | 9.2.1.74 | | — | |
| MAC-d Flow | | | | | | |
| ID | | | | | | |
| >Binding ID | O | | 9.2.1.4 | Shall be | — | |
| | | | | ignored if | | |
| | | | | bearer | | |
| | | | | establishment | | |
| | | | | with ALCAP | | |
| >Transport | O | | 9.2.1.63 | Shall be | — | |
| Layer | | | | ignored if | | |
| Address | | | | bearer | | |
| | | | | establishment | | |
| | | | | with ALCAP | | |
| HARQ | O | | HARQ | | — | |
| Process | | | Process | | | |
| Allocation For | | | Allocation for | | | |
| 2 ms | | | 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum Set | | | (0 . . . 127) | concept of “E- | | |
| E-TFCI | | | | DCH Minimum | | |
| | | | | Set of TFCs” | | |
| | | | | see TS 25.321 | | |
| | | | | [32] and TS | | |
| | | | | 25.331 [18] | | |
| DTX | | 0 . . . 1 | | | | |
| Information2 | | | | | | |
| >UE DTX | M | | ENUMERATED | Units of | YES | ignore |
| Cycle 1 | | | (v1, v4, | subframes, | | |
| | | | v5, v8, v10, | refer to TS | | |
| | | | v16, v20, . . .) | 25.331 [16]. | | |
| >UE DTX | M | | ENUMERATED | Units of | YES | ignore |
| Cycle 2 | | | (v4, v5, | subframes, | | |
| | | | v8, v10, v16, | refer to TS | | |
| | | | v20, v32, | 25.331 [16]. | | |
| | | | v40, v64, | | | |
| | | | v80, v128, | | | |
| | | | v160, v256, | | | |
| | | | v320, v512, | | | |
| | | | v640, v1024, | | | |
| | | | v1280, . . .) | | | |
| >Inactivity | M | | ENUMERATED | Units of E- | YES | ignore |
| Threshold | | | (v1, v4, | DCH TTIs, | | |
| for UE DTX | | | v8, v16, v32, | refer to TS | | |
| Cycle 2 | | | v64, v128, | 25.331 [16]. | | |
| | | | v256, . . .) | | | |
| Implicit Grant | O | | ENUMERATED | The presence | YES | ignore |
| handling | | | (true) | of this | | |
| | | | | information | | |
| | | | | element | | |
| | | | | indicates that | | |
| | | | | Implicit Grant | | |
| | | | | handling is | | |
| | | | | configured on | | |
| | | | | the secondary | | |
| | | | | uplink | | |
| | | | | frequency | | |
| Minimum | O | | ENUMERATED | In bytes | YES | ignore |
| TEBS | | | (v2, v4, | And N Kbytes = | | |
| threshold | | | v8, v16, v32, | N*1024 | | |
| | | | v64, v128, | bytes. Twelve | | |
| | | | v256, v512, | spare values | | |
| | | | v1024, v2K, | are needed, | | |
| | | | v4K, v8K, | refer to TS | | |
| | | | v16K, v32K, | 25.331 [16]. | | |
| | | | v64K, | | | |
| | | | v128K, | | | |
| | | | v256K, | | | |
| | | | v512K, | | | |
| | | | V1024K, . . .) | | | |
| E-TTI | O | | ENUMERATED | The | YES | reject |
| | | | (10 ms) | absence of | | |
| | | | | this IE | | |
| | | | | means 2 ms | | |
| | | | | TTI. | | |

Table 3, below is extract from TS 25.433 (v. 12.0.0), 9.2.2.137 Additional E-DCH FDD Information. In this example, a new IE “E-TTI” is introduced which may be set to “2 ms” and “10 ms”. It may also be specified in the specification that if both Node B and RNC supports the new Rel 14 III configuration for DC-HSUPA/DB-DC-HSUPA, it always includes the E-TTI IE in secondary E-DCH carrier. In this example, the new IE may have criticality as “ignore”.

| IE/Group | | | IE Type and | Semantics | | Assigned |
|---|---|---|---|---|---|---|
| Name | Presence | Range | Reference | Description | Criticality | Criticality |
| Additional E- | | 0 . . . <maxNrOfEDCHMACdFlows> | | | | |
| DCH MAC-d | | | | | | |
| Flows | | | | | | |
| Specific | | | | | | |
| Information | | | | | | |
| >E-DCH | M | | 9.2.1.74 | | — | |
| MAC-d Flow | | | | | | |
| ID | | | | | | |
| >Binding ID | O | | 9.2.1.4 | Shall be | — | |
| | | | | ignored if | | |
| | | | | bearer | | |
| | | | | establishment | | |
| | | | | with ALCAP | | |
| >Transport | O | | 9.2.1.63 | Shall be | — | |
| Layer | | | | ignored if | | |
| Address | | | | bearer | | |
| | | | | establishment | | |
| | | | | with ALCAP | | |
| HARQ | O | | HARQ | | — | |
| Process | | | Process | | | |
| Allocation For | | | Allocation for | | | |
| 2 ms | | | 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum Set | | | (0 . . . 127) | concept of “E- | | |
| E-TFCI | | | | DCH Minimum | | |
| | | | | Set of TFCs” | | |
| | | | | see TS 25.321 | | |
| | | | | [32] and TS | | |
| | | | | 25.331 [18] | | |
| DTX | | 0 . . . 1 | | | | |
| Information2 | | | | | | |
| >UE DTX | M | | ENUMERATED | Units of | YES | ignore |
| Cycle 1 | | | (v1, v4, | subframes, | | |
| | | | v5, v8, v10, | refer to TS | | |
| | | | v16, v20, . . .) | 25.331 [16]. | | |
| >UE DTX | M | | ENUMERATED | Units of | YES | ignore |
| Cycle 2 | | | (v4, v5, | subframes, | | |
| | | | v8, v10, v16, | refer to TS | | |
| | | | v20, v32, | 25.331 [16]. | | |
| | | | v40, v64, | | | |
| | | | v80, v128, | | | |
| | | | v160, v256, | | | |
| | | | v320, v512, | | | |
| | | | v640, v1024, | | | |
| | | | v1280, . . .) | | | |
| >Inactivity | M | | ENUMERATED | Units of E- | YES | ignore |
| Threshold | | | (v1, v4, | DCH TTIs, | | |
| for UE DTX | | | v8, v16, v32, | refer to TS | | |
| Cycle 2 | | | v64, v128, | 25.331 [16]. | | |
| | | | v256, . . .) | | | |
| Implicit Grant | O | | ENUMERATED | The presence | YES | ignore |
| handling | | | (true) | of this | | |
| | | | | information | | |
| | | | | element | | |
| | | | | indicates that | | |
| | | | | Implicit Grant | | |
| | | | | handling is | | |
| | | | | configured on | | |
| | | | | the secondary | | |
| | | | | uplink | | |
| | | | | frequency | | |
| Minimum | O | | ENUMERATED | In bytes | YES | ignore |
| TEBS | | | (v2, v4, | And N Kbytes = | | |
| threshold | | | v8, v16, v32, | N*1024 | | |
| | | | v64, v128, | bytes. Twelve | | |
| | | | v256, v512, | spare values | | |
| | | | v1024, v2K, | are needed, | | |
| | | | v4K, v8K, | refer to TS | | |
| | | | v16K, v32K, | 25.331 [16]. | | |
| | | | v64K, | | | |
| | | | v128K, | | | |
| | | | v256K, | | | |
| | | | v512K, | | | |
| | | | V1024K, . . .) | | | |
| E-TTI | O | | ENUMERATED | | YES | reject or |
| | | | (2 ms, | | | ignore |
| | | | 10 ms) | | | |

Table 4, below is an example to add in the NBAP/RNASP specification:

New procedure text

For the secondary E-DCH carrier, if the Node B indicates the Rel
14 new TTI configuration in DC-HSUPA and DB-DC-HSUPA, and
RNC supports it as well, the E-TTI IE in the secondary E-DCH
carrier shall always be included.

Table 5, below is extract from TS 25.433 (v. 12.0.0), 9.2.2.137 Additional E-DCH FDD Information. In this example, the new second IE “New III Configuration Indicator” is introduced to indicate that the RNC is intending to setup the Rel 14 new III configuration in the secondary E-DCH carrier. A new first “E-TTI” IE is introduced as a conditional IE. The condition is specified.

| IE/Group | | | IE Type and | Semantics | | Assigned |
|---|---|---|---|---|---|---|
| Name | Presence | Range | Reference | Description | Criticality | Criticality |
| Additional | | 0 . . . <maxNrOfEDCHMACdFlows> | | | | |
| E-DCH | | | | | | |
| MAC-d | | | | | | |
| Flows | | | | | | |
| Specific | | | | | | |
| Information | | | | | | |
| >E-DCH | M | | 9.2.1.74 | | — | |
| MAC-d | | | | | | |
| Flow ID | | | | | | |
| >Binding | O | | 9.2.1.4 | Shall be | — | |
| ID | | | | ignored if | | |
| | | | | bearer | | |
| | | | | establishment | | |
| | | | | with | | |
| | | | | ALCAP | | |
| >Transport | O | | 9.2.1.63 | Shall be | — | |
| Layer | | | | ignored if | | |
| Address | | | | bearer | | |
| | | | | establishment | | |
| | | | | with | | |
| | | | | ALCAP | | |
| HARQ | O | | HARQ | | — | |
| Process | | | Process | | | |
| Allocation | | | Allocation | | | |
| For 2 ms | | | for 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum | | | (0 . . . 127) | concept of | | |
| Set E-TFCI | | | | “E-DCH | | |
| | | | | Minimum | | |
| | | | | Set of | | |
| | | | | TFCs” see | | |
| | | | | TS 25.321 | | |
| | | | | [32] and TS | | |
| | | | | 25.331 [18] | | |
| DTX | | 0 . . . 1 | | | | |
| Information2 | | | | | | |
| >UE DTX | M | | ENUMERATED | Units of | YES | ignore |
| Cycle 1 | | | (v1, | subframes, | | |
| | | | v4, v5, v8, | refer to TS | | |
| | | | v10, v16, | 25.331 | | |
| | | | v20, . . .) | [16]. | | |
| >UE DTX | M | | ENUMERATED | Units of | YES | ignore |
| Cycle 2 | | | (v4, | subframes, | | |
| | | | v5, v8, v10, | refer to TS | | |
| | | | v16, v20, | 25.331 | | |
| | | | v32, v40, | [16]. | | |
| | | | v64, v80, | | | |
| | | | v128, v160, | | | |
| | | | v256, v320, | | | |
| | | | v512, v640, | | | |
| | | | v1024, | | | |
| | | | v1280, . . .) | | | |
| >Inactivity | M | | ENUMERATED | Units of E- | YES | ignore |
| Threshold | | | (v1, | DCH TTIs, | | |
| for UE DTX | | | v4, v8, v16, | refer to TS | | |
| Cycle 2 | | | v32, v64, | 25.331 | | |
| | | | v128, | [16]. | | |
| | | | v256, . . .) | | | |
| Implicit | O | | ENUMERATED | The | YES | ignore |
| Grant | | | (true) | presence | | |
| handling | | | | of this | | |
| | | | | information | | |
| | | | | element | | |
| | | | | indicates | | |
| | | | | that Implicit | | |
| | | | | Grant | | |
| | | | | handling is | | |
| | | | | configured | | |
| | | | | on the | | |
| | | | | secondary | | |
| | | | | uplink | | |
| | | | | frequency | | |
| Minimum | O | | ENUMERATED | In bytes | YES | ignore |
| TEBS | | | (v2, | And N | | |
| threshold | | | v4, v8, v16, | Kbytes = | | |
| | | | v32, v64, | N*1024 | | |
| | | | v128, v256, | bytes. | | |
| | | | v512, | Twelve | | |
| | | | v1024, | spare | | |
| | | | v2K, v4K, | values are | | |
| | | | v8K, v16K, | needed, | | |
| | | | v32K, | refer to TS | | |
| | | | v64K, | 25.331 | | |
| | | | v128K, | [16]. | | |
| | | | v256K, | | | |
| | | | v512K, | | | |
| | | | V1024K, . . .) | | | |
| New TTI | O | | NULL | Indicates | YES | reject |
| Configuration | | | | Rel 14 | | |
| Indicator | | | | the new | | |
| | | | | TTI | | |
| | | | | configuration | | |
| | | | | in | | |
| | | | | DC- | | |
| | | | | HSUPA | | |
| | | | | and DB- | | |
| | | | | DC- | | |
| | | | | HSUPA | | |
| E-TTI | C- New | | ENUMERATED | | YES | reject |
| | TTI | | (2 ms, | | | |
| | Configuration | | 10 ms) | | | |
| | Indicator | | | | | |

| Condition | Explanation |
|---|---|
| New TTI Configuration Indicator | This IE shall be present if the New TTI Configuration |
| | Indicator IE is presented |

Table 6, below is an extract from TS 25.433, 8.2.17.4 Abnormal Conditions. In this example, we introduce the failure handling if the E-TTI is not presented while RNC is intending to setup the Rel 14 multicarrier III configuration, e.g. some of the III configuration, 2 ms+10 ms. 10 ms+10 ms, 10 ms+2 ms.

| | New Abnormal handling |
|---|---|
| | Example |
| 8.2.17.4 Abnormal | For the secondary E-DCH |
| Conditions | carrier, if the RNC indicate |
| | the Rel 14 new TTI |
| | configuration in DC-HSUPA |
| | and DB-DC-HSUPA, but the |
| | E-TTI IE is not presented |
| | then the Node B shall reject |
| | the procedure using the |
| | RADIO LINK SETUP |
| | FAILURE message. |

Table 7, below is an extract from 3GPP TS 25.433 (v. 12.0.0), 9.2.2.137 Additional E-DCH FDD Information. In this example, we introduce a new IE “E-TTI” which may e.g. be set to “10 ms”.

| IE/Group | | | IE Type and | Semantics | | Assigned |
|---|---|---|---|---|---|---|
| Name | Presence | Range | Reference | Description | Criticality | Criticality |
| Additional | | 0 . . . <maxNrOfEDCHMACdFlows> | | | | |
| E-DCH | | | | | | |
| MAC-d | | | | | | |
| Flows | | | | | | |
| Specific | | | | | | |
| Information | | | | | | |
| >E-DCH | M | | 9.2.1.74 | | — | |
| MAC-d | | | | | | |
| Flow ID | | | | | | |
| >Binding | O | | 9.2.1.4 | Shall be | — | |
| ID | | | | ignored if | | |
| | | | | bearer | | |
| | | | | establishment | | |
| | | | | with | | |
| | | | | ALCAP | | |
| >Transport | O | | 9.2.1.63 | Shall be | — | |
| Layer Address | | | | ignored if | | |
| | | | | bearer | | |
| | | | | establishment | | |
| | | | | with | | |
| | | | | ALCAP | | |
| HARQ | O | | HARQ | | — | |
| Process | | | Process | | | |
| Allocation | | | Allocation | | | |
| For 2 ms | | | for 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum | | | (0 . . . 127) | concept of | | |
| Set E-TFCI | | | | “E-DCH | | |
| | | | | Minimum | | |
| | | | | Set of | | |
| | | | | TFCs” see | | |
| | | | | TS 25.321 | | |
| | | | | [32] and TS | | |
| | | | | 25.331 [18] | | |
| 10 ms TTI | O | | NULL | Indicates | YES | reject |
| Configuration | | | | the | | |
| Indicator | | | | secondary | | |
| | | | | E-DCH | | |
| | | | | is on | | |
| | | | | 10 ms TTI | | |
| E-TTI | C- 10 ms | | ENUMERATED | | YES | reject |
| | TTI | | (10 ms) | | | |
| | Configuration | | | | | |
| | Indicator | | | | | |
| DTX | | 0 . . . 1 | | | | |
| Information2 | | | | | | |
| >UE DTX | M | | ENUMERATED | Units of | YES | ignore |
| Cycle 1 | | | (v1, | subframes, | | |
| | | | v4, v5, v8, | refer to TS | | |
| | | | v10, v16, | 25.331 | | |
| | | | v20, . . .) | [16]. | | |
| >UE DTX | M | | ENUMERATED | Units of | YES | ignore |
| Cycle 2 | | | (v4, | subframes, | | |
| | | | v5, v8, v10, | refer to TS | | |
| | | | v16, v20, | 25.331 | | |
| | | | v32, v40, | [16]. | | |
| | | | v64, v80, | | | |
| | | | v128, v160, | | | |
| | | | v256, v320, | | | |
| | | | v512, v640, | | | |
| | | | v1024, | | | |
| | | | v1280, . . .) | | | |
| >Inactivity | M | | ENUMERATED | Units of E- | YES | ignore |
| Threshold | | | (v1, | DCH TTIs, | | |
| for UE | | | v4, v8, v16, | refer to TS | | |
| DTX | | | v32, v64, | 25.331 | | |
| Cycle 2 | | | v128, | [16]. | | |
| | | | v256, . . .) | | | |
| Implicit | O | | ENUMERATED | The | YES | ignore |
| Grant | | | (true) | presence | | |
| handling | | | | of this | | |
| | | | | information | | |
| | | | | element | | |
| | | | | indicates | | |
| | | | | that Implicit | | |
| | | | | Grant | | |
| | | | | handling is | | |
| | | | | configured | | |
| | | | | on the | | |
| | | | | secondary | | |
| | | | | uplink | | |
| | | | | frequency | | |
| Minimum | O | | ENUMERATED | In bytes | YES | ignore |
| TEBS | | | (v2, | And N | | |
| threshold | | | v4, v8, v16, | Kbytes = | | |
| | | | v32, v64, | N*1024 | | |
| | | | v128, v256, | bytes. | | |
| | | | v512, | Twelve | | |
| | | | v1024, | spare | | |
| | | | v2K, v4K, | values are | | |
| | | | v8K, v16K, | needed, | | |
| | | | v32K, | refer to TS | | |
| | | | v64K, | 25.331 | | |
| | | | v128K, | [16]. | | |
| | | | v256K, | | | |
| | | | v512K, | | | |
| | | | V1024K, . . .) | | | |
| 10 ms TTI | O | | NULL | Indicates | YES | reject |
| Configuration | | | | the | | |
| Indicator | | | | secondary | | |
| | | | | E-DCH | | |
| | | | | is on | | |
| | | | | 10 ms TTI | | |
| E-TTI | C- 10 ms | | ENUMERATED | | YES | reject |
| | TTI | | (10 ms) | | | |
| | Configuration | | | | | |
| | Indicator | | | | | |

| Condition | Explanation |
|---|---|
| 10 ms TTI Configuration Indicator | This IE shall be present if the 10 ms TTI |
| | Configuration Indicator IE is presented |

Table 8, below is extract from TS 25.433 (v. 12.0.0), 9.2.2.137 Additional E-DCH FDD Information. In this example, we introduce a new IE “10 ms III Indicator” which can be set to “10 ms III used, 10 ms III removed”.

| IE/Group | | | IE Type and | Semantics | | Assigned |
|---|---|---|---|---|---|---|
| Name | Presence | Range | Reference | Description | Criticality | Criticality |
| Additional | | 0 . . . <maxNrOfEDCHMACdFlows> | | | | |
| E-DCH | | | | | | |
| MAC-d | | | | | | |
| Flows | | | | | | |
| Specific | | | | | | |
| Information | | | | | | |
| >E-DCH | M | | 9.2.1.74 | | — | |
| MAC-d | | | | | | |
| Flow ID | | | | | | |
| >Binding | O | | 9.2.1.4 | Shall be | — | |
| ID | | | | ignored if | | |
| | | | | bearer | | |
| | | | | establishment | | |
| | | | | with | | |
| | | | | ALCAP | | |
| >Transport | O | | 9.2.1.63 | Shall be | — | |
| Layer | | | | ignored if | | |
| Address | | | | bearer | | |
| | | | | establishment | | |
| | | | | with | | |
| | | | | ALCAP | | |
| HARQ | O | | HARQ | | — | |
| Process | | | Process | | | |
| Allocation | | | Allocation | | | |
| For 2 ms | | | for 2 ms TTI | | | |
| Scheduled | | | 9.2.2.13Dn | | | |
| Transmission | | | | | | |
| Grant | | | | | | |
| E-DCH | O | | 9.2.2.13T | | — | |
| Maximum | | | | | | |
| Bitrate | | | | | | |
| E-DCH | O | | 9.2.1.79 | | — | |
| Processing | | | | | | |
| Overload | | | | | | |
| Level | | | | | | |
| E-DCH | O | | INTEGER | For the | — | |
| Minimum | | | (0 . . . 127) | concept of | | |
| Set E-TFCI | | | | “E-DCH | | |
| | | | | Minimum | | |
| | | | | Set of | | |
| | | | | TFCs” see | | |
| | | | | TS 25.321 | | |
| | | | | [32] and TS | | |
| | | | | 25.331 [18] | | |
| DTX | | 0 . . . 1 | | | | |
| Information2 | | | | | | |
| >UE DTX | M | | ENUMERATED | Units of | YES | ignore |
| Cycle 1 | | | (v1, | subframes, | | |
| | | | v4, v5, v8, | refer to TS | | |
| | | | v10, v16, | 25.331 | | |
| | | | v20, . . .) | [16]. | | |
| >UE DTX | M | | ENUMERATED | Units of | YES | ignore |
| Cycle 2 | | | (v4, | subframes, | | |
| | | | v5, v8, v10, | refer to TS | | |
| | | | v16, v20, | 25.331 | | |
| | | | v32, v40, | [16]. | | |
| | | | v64, v80, | | | |
| | | | v128, v160, | | | |
| | | | v256, v320, | | | |
| | | | v512, v640, | | | |
| | | | v1024, | | | |
| | | | v1280, . . .) | | | |
| >Inactivity | M | | ENUMERATED | Units of E- | YES | ignore |
| Threshold | | | (v1, | DCH TTIs, | | |
| for UE | | | v4, v8, v16, | refer to TS | | |
| DTX | | | v32, v64, | 25.331 | | |
| Cycle 2 | | | v128, | [16]. | | |
| | | | v256, . . .) | | | |
| Implicit | O | | ENUMERATED | The | YES | ignore |
| Grant | | | (true) | presence | | |
| handling | | | | of this | | |
| | | | | information | | |
| | | | | element | | |
| | | | | indicates | | |
| | | | | that Implicit | | |
| | | | | Grant | | |
| | | | | handling is | | |
| | | | | configured | | |
| | | | | on the | | |
| | | | | secondary | | |
| | | | | uplink | | |
| | | | | frequency | | |
| Minimum | O | | ENUMERATED | In bytes | YES | ignore |
| TEBS | | | (v2, | And N | | |
| threshold | | | v4, v8, v16, | Kbytes = | | |
| | | | v32, v64, | N*1024 | | |
| | | | v128, v256, | bytes. | | |
| | | | v512, | Twelve | | |
| | | | v1024, | spare | | |
| | | | v2K, v4K, | values are | | |
| | | | v8K, v16K, | needed, | | |
| | | | v32K, | refer to TS | | |
| | | | v64K, | 25.331 | | |
| | | | v128K, | [16]. | | |
| | | | v256K, | | | |
| | | | v512K, | | | |
| | | | V1024K, . . .) | | | |
| 10 ms TTI | O | | ENUMERATED | | YES | reject |
| Indicator | | | (10 ms | | | |
| | | | TTI used, | | | |
| | | | 10 ms TTI | | | |
| | | | removed) | | | |

### ABBREVIATIONS

### HSUPA High Speed Uplink Packet Access

E-DCH uplink enhanced dedicated channel

### RNC Radio Network Controller

### SRNC Serving Radio Network Controller

### DRNC Drifting Radio Network Controller

### NBAP Node B Application Part

### RNSAP Radio Network Subsystem Application Part

### DC-HSUPA Dual Cell HSUPA

### DB-DC-HSUPA Dual Band DC-HSUPA

1. A method, performed by a Radio Network Controller, RNC, for setting up a secondary uplink carrier, wherein the method comprises:
sending a dedicated radio link message to a network node, wherein the dedicated radio link message comprises a first Information Element, IE, which indicates a Transmission Time Interval, TTI, value out of a plurality of TTI values available for the radio link.

2. The method according to claim 1, wherein the method further comprises,
receiving, prior to sending the dedicated radio link message to the network node, an indication from the network node, wherein the indication indicates that the network node supports a variable TTI for the secondary uplink carrier.

3. The method according to claim 1 wherein the method further comprises:
determining to send the first IE in the dedicated radio link message based on the received indication from the network node.

4. The method according to claim 1, wherein the dedicated radio link message comprises a second IE, which IE indicates to the network node that a variable TTI configuration is set up.

5. The method according to claim 4, wherein when the second IE indicates that a variable TTI configuration is being set up, the value of the variable TTI is indicated by the first IE in the radio link message.

6. A method, performed by a network node, for setting up a secondary uplink carrier, wherein the method comprises:
receiving a dedicated radio link message from a Radio Network Controller, RNC, wherein the dedicated radio link message comprises a first Information Element, IE, which indicates a Transmission Time Interval, TTI, value out of a plurality of TTI values available for the secondary uplink carrier.

7. The method according to claim 6, wherein the method further comprises, prior to receiving the dedicated radio link message from the RNC,
sending an indication to the RNC, wherein the indication indicates that the network node supports a variable TTI for the secondary uplink carrier.

8. The method according to claim 6, wherein the network node receives the first IE in the dedicated radio link message based on the sent indication, such that the network node receives the IE when it has indicated that it supports a variable TTI.

9. The method according to claim 6, wherein the dedicated radio link message comprises a second IE, wherein the second IE indicates to the network node that a variable TTI configuration is set up.

10. The method according to claim 9, wherein when the second IE indicates a variable TTI configuration, the value of the variable TTI is indicated by the first IE.

11. The method according to claim 6, wherein the method further comprises:
setting up the secondary uplink carrier in the radio communications network based on the TTI value indicated by the first IE comprised in the dedicated radio link message.

12. The method according to claim 6, wherein the method when the network node fails to execute the procedure based on the received dedicated radio link message, further comprises:
reacting according to an abnormal condition, wherein the abnormal condition comprises failing the current secondary uplink carrier setup procedure.

13. The method according to claim 6, wherein the method when the network node fails to execute the procedure based on the received dedicated radio link message, further comprises:
reacting according to an abnormal condition, wherein the abnormal condition comprises continuing the secondary uplink carrier setup procedure with a predefined TTI value.

14. A Radio Network Controller, RNC, for setting up a secondary uplink carrier and comprising a processor and a memory, said memory containing instructions executable by said processor to cause the RNC to:
send a dedicated radio link message to a network node, wherein the dedicated radio link message comprises a first Information Element, IE, which indicates a Transmission Time Interval, TTI, value out of a plurality of TTI values available for the radio link.

15. The RNC according to claim 14, wherein the RNC further is configured to,
receive, prior to sending the dedicated radio link message to the network node, an indication from the network node, wherein the indication indicates that the network node supports a variable TTI for the secondary uplink carrier.

16. The RNC according to claim 14, wherein the RNC is further configured to:
determine to send the first IE in the dedicated radio link message based on the received indication from the network node.

17. A network node, for performing a method for setting up a secondary uplink carrier and comprising a processor and a memory, said memory containing instructions executable by said processor to cause the network node to:
receive a dedicated radio link message from a Radio Network Controller, RNC, wherein the dedicated radio link message comprises a first Information Element, IE, which indicates a Transmission Time Interval, TTI, value out of a plurality of TTI values available for the secondary uplink carrier.

18. The network node according to claim 17, wherein the network node is further configured to:
send, prior to receiving the dedicated radio link message from the RNC, an indication to the RNC, wherein the indication indicates that the network node supports a variable TTI for the secondary uplink carrier.

19. The network node according to claim 17, wherein the network node is configured to receive the IE in the dedicated radio link message based on the sent indication, such that the network node receives the IE when it has indicated that it supports a variable TTI.

20. The network node according to claim 17, wherein the dedicated radio link message comprises a second IE, wherein the second IE indicates to the network node that a variable TTI configuration is set up.

21. The network node according to claim 17, wherein the network node further is configured to:
set up the secondary uplink carrier in the radio communications network based on the TTI value indicated by the first IE comprised in the dedicated radio link message.

22. The network node according to claim 17, wherein the network node, when the network node fails to execute the procedure based on the received dedicated radio link message, further is configured to:
react according to an abnormal condition, wherein the abnormal condition comprises failing the current secondary uplink carrier setup procedure.

23. The network node according to claim 17, wherein the network node, when the network node fails to execute the procedure based on the received dedicated radio link message, further is configured to:
react according to an abnormal condition, wherein the abnormal condition comprises continuing the secondary uplink carrier setup procedure with a predefined TTI value.

24-34. (canceled)
